(19) United States
(12) Patent Application Publication
(10) Pub. No.: US 2007/0062118 A1
(43) Pub. Date: Mar. 22, 2007

(54) Door arrangement for a motor vehicle

(75) Inventors: Ingrid Lindemann, Grafenau (DE); Hansjoerg Traub, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysier AG, Stuttgart (DE)

(21) Appl. No.: 10/564,394

(22) PCT Filed: Jul. 7, 2004
(86) PCT No.: PCT/EP04/07403

§ 371 Date: May 17, 2006

(30) Foreign Application Priority Data
Jul. 15, 2003 (DE) 103 32 026.1

(51) Int. Cl. E05D 15/10

(52) U.S. Cl. 49/209; 49/360

(57) ABSTRACT

A door arrangement for closing an entry opening of a motor vehicle includes a first swing-and-slide door which is assigned to a first opening region and a second swing-and-slide door which is assigned to a second opening region. In a closed state, the two swing-and-slide doors are arranged in a first plane, in which a side wall adjacent to the entry opening is also arranged. In the open state, the first swing-and-slide door is situated in a second plane offset outward parallel to the first plane, and is arranged next to the first opening region and on the outside in front of the side wall. In the open state, the second swing-and-slide door is arranged in a third plane offset outward parallel to the second plane, and next to the first opening region and on the outside in front of the side wall.

### BACKGROUND AND SUMMARY OF THE INVENTION

This application claims the priority of German patent document 103 32 026.1, filed Jul. 15, 2003 (PCT International Application No. PCT/EP2004/007403, filed Jul. 7, 2004), the disclosure of which is expressly incorporated by reference herein.

The invention relates to a door arrangement for closing an entry opening of a motor vehicle.

German patent document DE 43 31 177A1 discloses a generic door arrangement which comprises a swing-and-slide door that can be moved between a closed state and an open state. In its closed state, the swing-and-slide door closes an opening region assigned to it and, in the process, is situated in a first plane, in which a side wall of the vehicle, adjacent to the entry opening, is also situated. In its open state, the swing-and-slide door opens up the opening region assigned to it and is arranged next to the entry opening in the longitudinal direction of the vehicle and on the outside in front of the side wall. The swing-and-slide door is then situated in a second plane offset outward parallel to the first plane.

In a door arrangement of this type, the longitudinal length of the side wall (in front of which the swing-and-slide door is situated in the open state) limits the opening width of the entry opening. In a drivers' cab which is of relatively short construction in the longitudinal direction of the vehicle, the side wall has a correspondingly small length, so that the entry opening also has a comparatively small opening width. In particular in a delivery vehicle, in which the driver passes individual objects to be delivered out of the vehicle through the entry opening, this may lead to problems with larger deliveries.

German patent document DE 296 08 211 U1 discloses a two-part sliding door for a vehicle, in which a side wall of the vehicle extends in a first plane while a first sliding door part extends in a second plane that is offset outward parallel with respect to the first plane. The second sliding door part is arranged in a third plane which is offset outward parallel with respect to the second plane. The first sliding door part is mounted on the vehicle so that it can be displaced longitudinally in the second plane. In a corresponding manner, the second sliding door part is also mounted so that it can be displaced longitudinally in the third plane. Since side wall and sliding door parts are situated in three different planes spaced apart from one another, a vehicle that is so equipped is relatively wide transversely compared with its longitudinal direction, which may be disadvantageous.

One object of the present invention is to provide an improved door arrangement of the type described above, which can be used in particular in a drivers' cab of a vehicle that is short in the longitudinal direction, particularly a transporter or any other desired commercial vehicle.

This and other objects and advantages are achieved by the door arrangement according to the invention, which is based on the general concept of providing two swing-and-slide doors which, in the closed state, are situated in the same plane as the side wall and which, in the open state, are situated in two different planes that are offset outward parallel to the first plane. This construction makes it possible for the entry opening to be of approximately twice the dimensions in the longitudinal direction of the vehicle as the side wall, so that loading and unloading of the vehicle through the entry opening can be facilitated even for bulky objects. Similarly, entry into and exit from the vehicle are facilitated. Furthermore, the door arrangement according to the invention is not built up in the transverse direction of the vehicle, at least in the closed state, and so, in the closed state, the swing-and-slide doors do not protrude outward over the side wall.

According to a particularly advantageous embodiment of the invention, the first swing-and-slide door can be mounted on the vehicle in such a manner that it can be swung and displaced, for example via a corresponding first swing-and-slide device while the second swing-and-slide door is mounted on the first swing-and-slide door in a manner such that it can be swung and displaced, for example via a corresponding second swing-and-slide device. The second swing-and-slide door can therefore always be moved relative to the first swing-and-slide door, while the first swing-and-slide door can be moved together with the second swing-and-slide door, which is mounted thereon, relative to the vehicle. The mounting of the second swing-and-slide door on the first swing-and-slide door enables a device for mounting the second swing-and-slide door to be structurally simplified. In particular, essentially structurally identical bearing devices, which merely have to be adapted slightly to the particular mounting configuration, can be used to mount both the first swing-and-slide door and the second swing-and-slide door.

Other objects, advantages and novel features of the present invention will become apparent from the following detailed description of the invention when considered in conjunction with the accompanying drawings.

### BRIEF DESCRIPTION OF THE DRAWINGS

FIGS. 1 to 5 are simplified side views of a door arrangement according to the invention in various states; and

FIGS. 6 to 10 are side views that correspond to FIGS. 1 to 5, but with different kinematics.

### DETAILED DESCRIPTION OF THE DRAWINGS

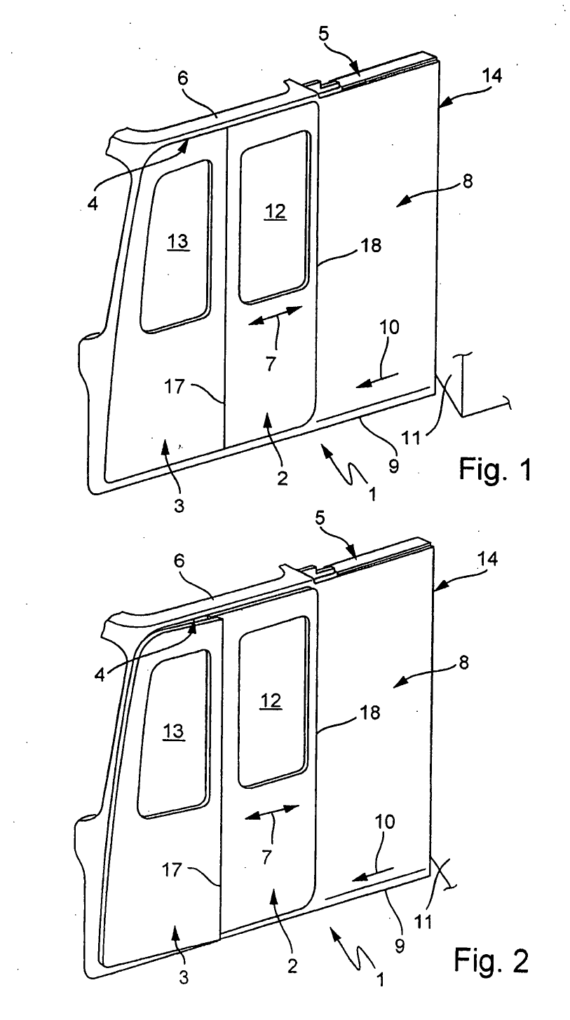

As shown in FIGS. 1 to 10, a door arrangement 1 according to the invention comprises a first swing-and-slide door 2 and a second swing-and-slide door 3, which serve to close a lateral entry opening 4 of a motor vehicle 5 (only partially illustrated). The entry opening 4 is bordered in a conventional manner by a door frame 6 and is adjacent to a side wall 8 of the vehicle 5 in a longitudinal direction 7 of the vehicle, symbolized by a double arrow. The vehicle 5 may be, for example, a transportation vehicle or any other desired commercial vehicle which is equipped with a driver's cab 9. The driver's cab 9 is arranged, with respect to a direction of travel 10 of the vehicle 5 (symbolized by an arrow), in front of a superstructure 11 (only partially indicated). The particular payload or load of the vehicle 5 can then be accommodated in this superstructure 11.

In the preferred embodiment shown, the first swing-and-slide door 2 is arranged behind the second swing-and-slide door 3 (with respect to the direction of travel 10), so that the first swing-and-slide door 2 may also be referred to as the rear swing-and-slide door 2 while the second swing-and-slide door 3 may also be referred to as the front swing-and-slide door 3. The first swing-and-slide door 2 is assigned to a first opening region 12 of the entry opening 4 while the second swing-and-slide door 3 is assigned to a second opening region 13. The two opening regions 12, 13 together form the entire entry opening 4.

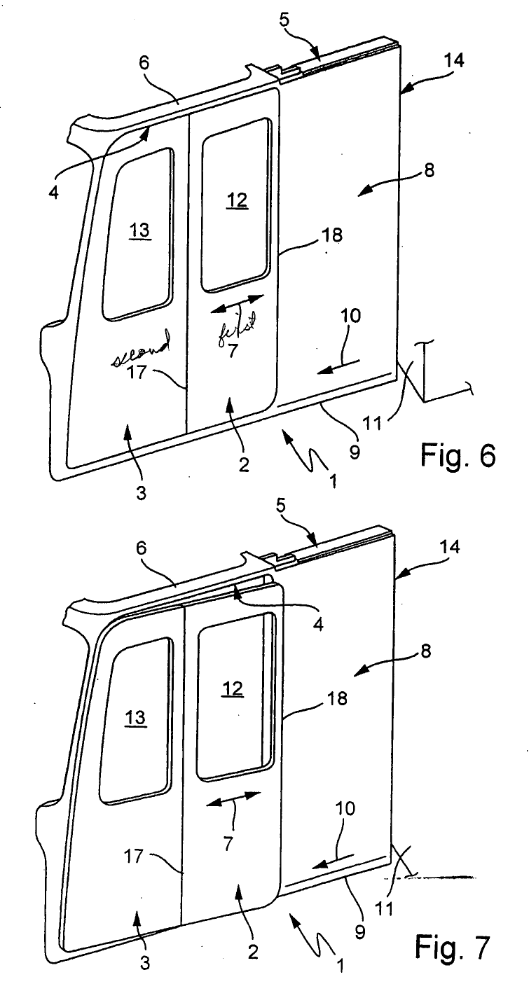

The side wall 8 is situated in a first plane 14 which extends essentially parallel to the longitudinal direction 7 of the vehicle, and is oriented essentially vertically. In a closed state of the door arrangement 1 (shown in FIGS. 1 and 6), the two swing-and-slide doors 2 and 3 are also situated essentially in this first plane 14. That is, the two swing-and-slide doors 2 and 3 end essentially flush with the side wall 8, forming a uniform side surface for the vehicle 5 or for its driver's cab 9.

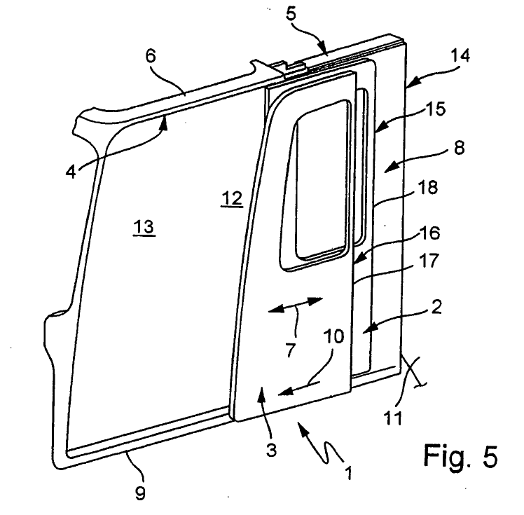

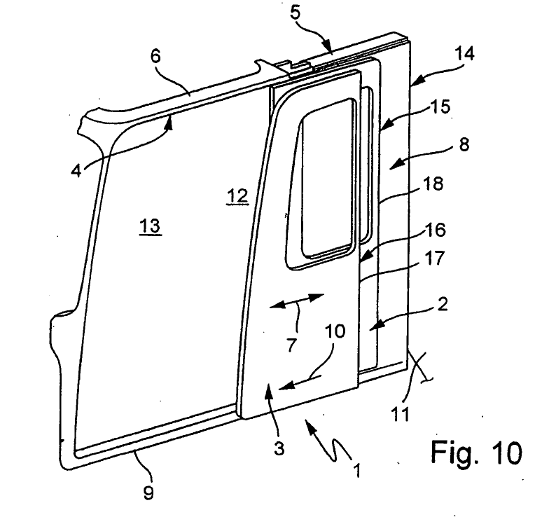

In the open state (FIGS. 5 and 10), the first swing-and-slide door 2 is situated in a second plane 15 which extends parallel to the first plane 14 and is spaced apart from the latter, outwardly with respect to the vehicle 5, and the second swing-and-slide door 3 is situated in a third plane 16 which also runs parallel to the first plane 14 and is spaced apart from the latter outward with respect to the vehicle 5. In the special embodiments shown here, the third plane 16 is arranged farther outward with respect to the vehicle 5 than the second plane 15. Accordingly, the second plane 15 is situated between the first plane 14 and the third plane 16.

In principle, different kinematics are also possible, in which, for example, the third plane 16 is arranged between the first plane 14 and the second plane 15, so that in the open state, the second swing-and-slide door 3 is accordingly situated between the side wall 8 and the first swing-and-slide door 2.

In the open state, the first swing-and-slide door 2 is arranged next to the opening entry 4 and, in particular, next to the first opening region 12. In this case, the first swing-and-slide door 2 is offset to the rear with respect to the direction of travel 10 and is slid on the outside in front of the side wall 8, so that it covers the side wall 8 essentially completely or congruently on the outside. In a corresponding manner, the second swing-and-slide door 3 is also arranged, in the open state, next to the entry opening 4 and next to the first opening region 12. The second swing-and-slide door 3 here is likewise displaced to the rear with respect to the direction of travel 10 in front of the side wall 8 in such a manner that the second swing-and-slide door 3 likewise covers the side wall 8 and therefore also the first swing-and-slide door 2 essentially completely or congruently on the outside.

As can clearly be seen in FIGS. 5 and 10, with the aid of the door arrangement 1 according to the invention the entry opening 4 can be approximately twice as large in the longitudinal direction 7 of the vehicle as the side wall 8. Advantageously, the two swing-and-slide doors 2, 3 are expediently of approximately identical dimensions in the longitudinal direction 7 of the vehicle, and approximately the same size in the longitudinal direction 7 of the vehicle as the side wall 8.

In addition, the kinematics of the door arrangement 1 can be matched to the superstructure 11 of the vehicle 5 in such a manner that the swing-and-slide door situated on the outside in the open state (here the second swing-and-slide door 3), does not protrude laterally over the superstructure 11 in the transverse direction of the vehicle. This ensures, for every parking situation, that the door arrangement 1 can be completely opened.

The first swing-and-slide door 2 is expediently mounted on the vehicle 5, in particular in the region of the frame 6 or in the region of the side wall 8. For this purpose, a corresponding first swing-and-slide device (not shown here) can be provided. Such swing-and-slide devices of this type are well know, and do not require further explanation. For example, German patent document DE 43 31 177 A1 , discussed previously, discloses a suitable swing-and-slide mounting.

In principle, it is now possible also to mount the second swing-and-slide door 3 on the vehicle 5 by means of a correspondingly adapted mounting in a manner such that it can be swung and displaced. In an embodiment of this type, the two swing-and-slide doors 2, 3 could be transferred independently of each other from their particular closed position into their particular open position, so that either the first opening region 12 or the second opening region 13 or both opening regions 12, 13 can be opened up.

However, in a preferred embodiment, the second swing-and-slide door 3 is mounted on the first swing-and-slide door 2 in a manner such that it can be swung and displaced. In this case, a suitable second swing-and-slide device can be essentially identical to the first swing-and-slide device, so that this variant can be realized at comparatively reasonable cost.

A first kinematics of the door arrangement 1 according to the invention is explained below with reference to FIGS. 1 to 5.

In the closed state according to FIG. 1, the two swing-and-slide doors 2, 3 are situated in the first plane 14 in which the side wall 8 is also situated. In this case, the swing-and-slide doors 2, 3 completely close the entry opening 4.

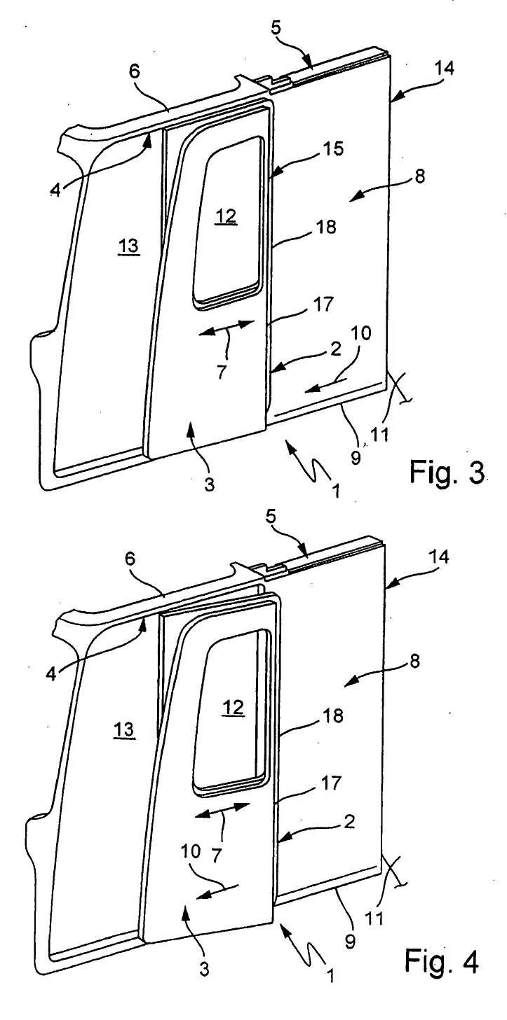

According to FIG. 2, to open the entry opening 4 first the second swing-and-slide door 3 is swung outward about a vertical swing axis at its end (relative to the direction of travel 10), so that a rearward edge 17 of the second swing-and-slide door 3 is moved outward. The rear edge 17 is thus situated on the outside in front of the first swing-and-slide door 2.

As shown in FIG. 3, the second swing-and-slide door 3 can then be offset outwardly and displaced rearwardly relative to the first swing-and-slide door 2 until it is arranged next to the second opening region 13. The second swing-and-slide door 3 therefore covers the first swing-and-slide door 2 essentially completely on the outside. This results in a half-open state in which the first swing-and-slide door 2 still closes the first opening region 12 assigned to it, while the second swing-and-slide door 3 opens up the second opening region 13. The first swing-and-slide door 2 is still situated in the first plane 14 while the second swing-and-slide door 3 is already offset to the outside, to be precise, expediently in such a way that it is situated essentially in the second plane 15.

In the half-open state, the door arrangement 1 provides a functional access for the vehicle driver without baggage or with smaller baggage.

As shown in FIG. 4, the first swing-and-slide door 2 can now be pivoted about a vertical axis at its front end in such a manner that a rear edge 18 is brought outward with respect to the side wall 8, and is therefore situated on the outside in front of the side wall 8. Since the second swing-and-slide door 3 is expediently mounted on the first swing-and-slide door 2, the second swing-and-slide door 3 follows the movement of the first swing-and-slide door 2.

According to FIG. 5, the first swing-and-slide door 2 can now be transferred together with the second swing-and-slide door 3 mounted on it, into the open state. In this case, the first swing-and-slide door 2 is slid in front of the side wall 8, since the first swing-and-slide door 2 is now offset outward into the second plane 15 and, as a result, the second swing-and-slide door 3 is automatically offset outward into the third plane 16.

The closing of the entry opening 4 then takes place in a corresponding reverse sequence.

A different kinematics for the door arrangement 1 according to the invention is explained in more detail below with reference to FIGS. 6 to 10.

Starting from the closed state according to FIG. 6, to open the entry opening 4 according to FIG. 7 the first swing-and-slide door 2 is swung, together with the second swing-and-slide door 3 attached to it, about a vertical axis which runs through the front end of the second swing-and-slide door 3. In this way, the rear edge 18 of the first swing-and-slide door 2 is brought outward with respect to the side wall 8. This rear edge 18 of the first swing-and-slide door 2 is then situated on the outside in front of the side wall 8.

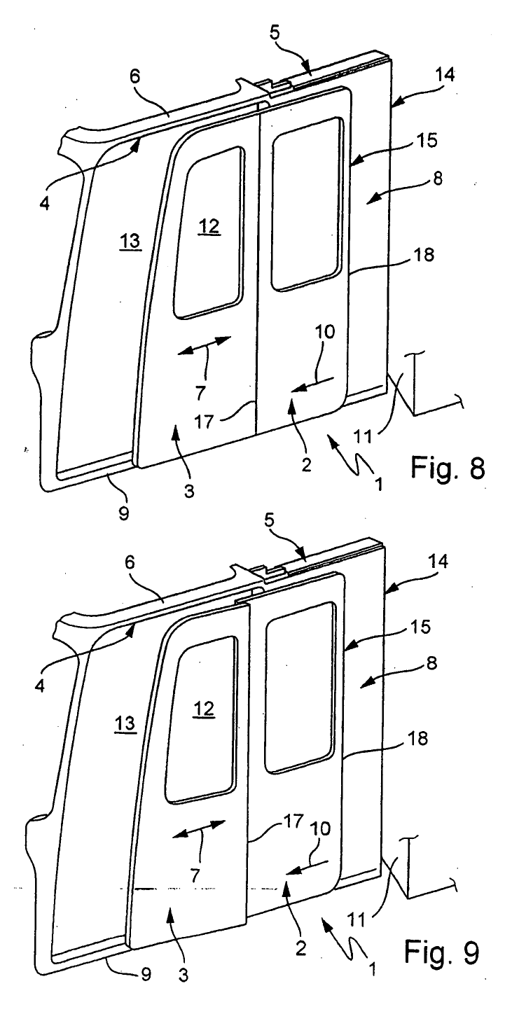

According to FIG. 8, the first swing-and-slide door 2 can now be displaced to the rear together with the second swing-and-slide door 3 attached to it, and at the same time can be swung outward until the first swing-and-slide door 2 essentially completely covers the side wall 8. By this means, a half-open state is also achieved in FIG. 8, in which the second opening region 13 is essentially completely opened up. In this half-open state, both the first swing-and-slide door 2 and the second swing-and-slide door 3 are situated in the second plane 15. The second swing-and-slide door 3 is then arranged next to the second opening region 13 and on the outside in front of the first opening region 12. In this half-open state, a comparatively narrow passage is again provided for the vehicle driver who can use it without baggage or with small baggage.

To further open the entry opening 4, according to FIG. 9 the second swing-and-slide door 3 can now be swung further about a vertical axis running through its front end in such a manner that its rear edge 17 is brought outward with respect to the first swing-and-slide door 2. The rear edge 17 of the second swing-and-slide door is therefore situated on the outside in front of the first swing-and-slide door 2.

According to FIG. 10, the second swing-and-slide door 3 can subsequently be slid to the rear over the first swing-and-slide door 2 until it essentially completely covers the latter. The open state according to FIG. 10 is subsequently present again, in which the second swing-and-slide door 3 is situated in the third plane 16 and is arranged essentially congruently to the first swing-and-slide door 2 and essentially congruently to the side wall 8. The entry opening 4 is then essentially completely opened up.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-10. (canceled)

11. A door arrangement for closing an entry opening of a motor vehicle, comprising at least one swing-and-slide door which can be moved between a closed state and an open state, such that in the closed state, the swing-and-slide door closes an opening region assigned to it, and is situated in a first plane in which a side wall of the vehicle adjacent to the entry opening, is also situated; and in the open state, the swing-and-slide door opens up the opening region assigned to it, and is situated next to the entry opening in the longitudinal direction of the vehicle, in a second plane offset outward parallel to the first plane, on the outside in front of the side wall; wherein:
the entry opening is assigned two swing-and-slide doors, including a first swing-and-slide door and a second swing-and-slide door, which can be moved between the closed state and the open state;
the first swing-and-slide door is assigned to a first opening region of the entry opening;
the second swing-and-slide door is assigned to a second opening region of the entry opening, which second opening region directly adjoins the first opening region in the first plane;
in the closed state, the two swing-and-slide doors jointly close the entry opening and are situated in the first plane;
in the open state, the first swing-and-slide door is situated in the second plane, offset outward parallel to the first plane, and is arranged next to the first opening region and on the outside in front of the side wall; and
in the open state, the second swing-and-slide door is situated in a third plane that is offset outward parallel to the second plane, and is arranged next to the first opening region and on the outside in front of the side wall.

12. The door arrangement as claimed in claim 11, wherein one of the following is true:
the second plane is situated between the first plane and the third plane, so that, in the open state, the second swing-and-slide door is arranged on the outside in front of the first swing-and-slide door; and
the third plane is situated between the first plane and the second plane, so that, in the open state, the first swing-and-slide door is arranged on the outside in front of the second swing-and-slide door.

13. The door arrangement as claimed in claim 11, wherein the first swing-and-slide door is mounted on the vehicle in a manner such that it can be swung and displaced.

14. The door arrangement as claimed in claim 13, wherein the second swing-and-slide door is mounted on the vehicle in a manner such that it can be swung and displaced.

15. The door arrangement as claimed in claim 13, wherein the second swing-and-slide door is mounted on the first swing-and-slide door in a manner such that it can be swung and displaced.

16. The door arrangement as claimed claim 11, wherein:
the swing-and-slide doors can be moved into a half-open state; and
in the half-open state, the first swing-and-slide door closes the first opening region and is situated in the first plane, and the second swing-and-slide door is situated essentially in the second plane, and is arranged on the outside in front of the first swing-and-slide door next to the second opening region in the longitudinal direction of the vehicle.

17. The door arrangement as claimed claim 11, wherein:
the swing-and-slide doors can be moved into a half-open state; and
in the half-open state, the first swing-and-slide door is arranged in the second plane and on the outside in front of the side wall, next to the first opening region in the longitudinal direction of the vehicle, and the second swing-and-slide door is situated substantially in the second plane, and is arranged on the outside in front of the first opening region between the second opening region and the first swing-and-slide door in the longitudinal direction of the vehicle.

18. The door arrangement as claimed in claim 11, wherein the two swing-and-slide doors are of approximately equal dimensions in the longitudinal direction of the vehicle.

19. The door arrangement as claimed in claim 11, wherein the two swing-and-slide doors and the side wall adjacent to the first opening region are of approximately equal dimensions in a longitudinal direction of the vehicle.

20. The door arrangement as claimed in claim 11, wherein the first swing-and-slide door is arranged behind the second swing-and-slide door in the direction of travel, so that, in the open state, the swing-and-slide doors can be moved rearward with respect to the entry opening, relative to a direction of travel of the vehicle.
